(19) United States
(12) Patent Application Publication
(10) Pub. No.: US 2012/0028207 A1
(43) Pub. Date: Feb. 2, 2012

(54) ORTHODONTIC CONNECTOR PROVIDING CONTROLLED ENGAGEMENT WITH AN ORTHODONTIC WIRE

(76) Inventors: James D. Cleary, Glendora, CA (US); Linda M. Galaviz, Manhattan Beach, CA (US)

(21) Appl. No.: 13/257,350

(22) PCT Filed: Apr. 5, 2010
(86) PCT No.: PCT/US10/29905

§ 371 Date: Sep. 19, 2011

Related U.S. Application Data
(60) Provisional application No. 61/168,959, filed on Apr. 14, 2009.

(51) Int. Cl. A61C 7/28; B23P 17/04

(52) U.S. Cl. 433/10; 29/428

(57) ABSTRACT

The present invention provides an orthodontic connector, along with related assemblies, used in coupling an orthodontic wire to an orthodontic auxiliary such a force module. The connector includes a slot with rigid and opposing walls and one or more flexible clips, which independently engage the wire. The combination of rigid and flexible components allows the connector to easily engage to and disengage from the wire and couple with a wide range of auxiliaries and fixed orthodontic appliances while simultaneously preventing the connector and associated auxiliary from unduly rotating about the longitudinal axis of the wire. Restricting this rotation advantageously prevents these components from either rotating into the occlusion or into the patient's soft tissue.

### BACKGROUND OF THE INVENTION

1. Field of the Invention

This invention relates to orthodontic connectors and related assemblies used in the course of orthodontic treatment. More particularly, the present invention is directed to orthodontic connectors and related assemblies for coupling a wire to a bite corrector, force module or other orthodontic auxiliaries in the oral cavity.

2. Description of the Related Art

Orthodontics is a specialized area in the field of dentistry associated with the supervision, guidance and correction of teeth to proper positions in the dental arch. Orthodontic therapy generally involves the judicious application of light continuous forces to move teeth into a proper bite configuration, or occlusion. One mode of therapy, known as “fixed appliance” treatment, is carried out using a set of tiny slotted appliances called brackets, which are affixed to the anterior, cuspid, and bicuspid teeth of a patient. In the beginning of treatment, a resilient orthodontic wire (or archwire) is received in each of the bracket slots. The end sections of the wire are typically anchored in appliances called buccal tubes, which are affixed to the patient's molar teeth.

When initially installed in the brackets and buccal tubes, the wire is deflected from its original shape, but then gradually returns to its original arcuate shape during treatment. In this manner, the wire applies gentle, therapeutic forces to move the teeth from maloccluded (or “crooked”) positions to orthodontically correct positions. Taken together, the brackets, buccal tubes, and wire are commonly referred to as “braces”. Braces are often prescribed to provide improved dental and facial aesthetics, improve the occlusion (bite) and mastication, and promote better dental hygiene.

Various orthodontic devices and assemblies may be prescribed during the course of treatment, based on the experience and expertise of the orthodontist. Orthodontic connectors, which couple one orthodontic device to another, play an important role in enabling these devices and assemblies to properly direct corrective forces to the teeth. Depending on the malocclusion being treated, these connectors can assist in directing forces between teeth within the upper or lower arch, between the upper and lower arches, or even between one or more teeth and a temporary anchorage device such as a mini-screw implanted into the jawbone.

Some of the especially challenging applications for orthodontic connectors are found in the area of orthodontic auxiliaries (accessory devices). These include intra-oral devices for correcting Class II malocclusions, where the mandibular first molars are located excessively distal (in the posterior direction) with respect to the maxillary first molars when the jaws are closed. Other exemplary auxiliaries include devices for correcting the opposite malocclusion, known as a Class III malocclusion, which occurs when mandibular first molars are located excessively mesial (in the anterior direction) with respect to the maxillary first molars when the jaws are closed. Both Class II and Class III malocclusions result in improper alignment between the teeth of the upper and lower arches.

Various intra-oral auxiliary devices for correcting Class II and Class III malocclusions have been reported in the art. For example, U.S. Pat. No. 5,964,588 (Cleary) describes an intra-oral bite corrector with a first member and a second member slidably received in the first member. A spring extends around the second member for urging the second member and the first member in directions away from each other. A third member is slidably received in the second member. Together, these members provide a force module device that urges the lower dental arch either in a forwardly or rearwardly direction relative to the upper dental arch in order to improve the occlusion.

Intra-oral correctors such as these are typically coupled to the teeth using connectors with flexible linkages that allow the device to pivot relative to the teeth as the patient's jaws open and close. One particular challenge in treating patients using these intra-oral correctors is that portions of the device can inadvertently pivot towards the adjacent oral tissue or into the occlusion during mastication. This can result in oral irritation or the patient biting down on the device, leading to patient discomfort, device breakage or both. Various approaches have been taken to address such undue rotational movements of associated components of the orthodontic corrector.

For example, pending U.S. Publication No. 2009/0035715 (Cleary), describes an orthodontic bite corrector with anti-rotation features. The disclosed couplings use a shank that is received in a passage of the buccal tube with a flexible, snap-in retention movement, along with rotation stops that are moved into operative positions as the shank is received in the passage. These rotation stops function to limit pivoting movement of the associated bite corrector so that the bite corrector does not contact adjacent oral tissue and cause irritation. However, there may be instances when treating certain malocclusions that the orthodontist prefers to avoid connecting the bite corrector to the buccal tube.

As an alternative, instead of coupling to the buccal tube, one or both ends of the intra-oral corrector may be coupled directly to the wire. U.S. Pat. No. 7,070,410 (Cacchiotti et al.) describes, for example, an orthodontic device with flexible members that clip onto a wire and includes a cap portion that receives and retains the force module. These flexible members can be displaced when the cap portion is placed over the wire and pressed into position, allowing the wire to be captured between them. However, these flexible members do not provide the rotational control of the device about the longitudinal axis of the wire.

### SUMMARY OF THE INVENTION

There is a need for an orthodontic connector that can be used with a wide range of orthodontic appliances and auxiliaries, can be easily installed and removed, and can secure those auxiliaries in a precise and controlled manner throughout treatment. The present invention addresses these needs by providing a connector in which both rigid and flexible components independently engage the wire. The combination of rigid and flexible components allows the connector to easily engage and disengage from the wire, while simultaneously preventing the attached auxiliaries from unduly rotating about the longitudinal axis of the wire. Restricting this rotation in turn prevents the auxiliary from rolling into the occlusion, which risks breakage of the device, or into the patient's cheek, which causes irritation.

In one aspect, the present invention is directed to an orthodontic assembly comprising a set of brackets, a wire connected to the brackets, and a connector for coupling an orthodontic auxiliary to the wire, the connector comprising a body, a slot extending across the body, and a clip coupled to the body, wherein the clip releasably retains the wire in the slot and wherein the slot includes a pair of rigid and opposing walls that restrict rotation of the connector body about the longitudinal axis of the wire.

In another aspect, the invention is directed to an orthodontic assembly comprising a connector for coupling a wire to an orthodontic auxiliary, the connector comprising a body having a lingual side, a slot extending across the lingual side of the body, and a clip coupled to the body for releasably retaining a wire in the slot, wherein the slot includes a pair of rigid and opposing walls that restrict rotation of the connector body about the longitudinal axis of a wire relative to the body while the wire is retained in the slot.

In still another aspect, the invention is directed to an orthodontic connector comprising a body, a slot extending across the body, and a clip coupled to the body for releasably retaining a wire in the slot, wherein the slot includes a pair of rigid and opposing walls that restrict rotation of the connector body about the longitudinal axis of a wire relative to the body while the wire is retained in the slot, and further wherein the connector lacks a bonding base that is adapted for attaching the connector to the surface of a tooth.

In yet another aspect, the invention is directed to a method of coupling a force module to a wire comprising providing a force module coupled to a connector, moving the connector in a direction toward a wire, sliding a pair of rigid and opposing walls of the connector along opposite sides of the wire, and coupling the connector to the wire by engaging the wire with at least one resilient clip of the connector such that the sides of the wire are adjacent the rigid walls.

These and other aspects of the invention are described in more detail in the paragraphs that follow and are illustrated in the accompanying drawings.

### BRIEF DESCRIPTION OF THE DRAWINGS

FIG. 1 is a side view of an orthodontic assembly according to one embodiment of the present invention as installed on a dental arch with fixed orthodontic appliances.

FIG. 2 is a perspective view of a connector in the orthodontic assembly of FIG. 1, looking at the lingual, mesial, and gingival sides.

FIG. 3 is a perspective view of the connector in FIG. 2, looking at the facial, mesial, and gingival sides.

FIG. 4 is a perspective view of the connector in FIGS. 2 and 3 in exploded form.

FIG. 5 is a perspective view of a connector according to another embodiment of the invention, looking at the distal, lingual, and gingival sides.

FIG. 6 is an occlusal view of the connector in FIG. 5, looking at the occlusal side.

FIG. 7 is a facial view of the connector in FIGS. 5 and 6, looking at the lingual side.

FIG. 8 is a side view of an orthodontic assembly according to another embodiment of the present invention.

### DEFINITIONS

As used herein:
“Mesial” means in a direction toward the center of the patient's curved dental arch.
“Distal” means in a direction away from the center of the patient's curved dental arch.
“Occlusal” means in a direction toward the outer tips of the patient's teeth.
“Gingival” means in a direction toward the patient's gums or gingiva.
“Facial” means in a direction toward the patient's lips or cheeks.
“Lingual” means in a direction toward the patient's tongue.

### DETAILED DESCRIPTION OF THE PREFERRED EMBODIMENTS

Further described below are orthodontic devices and assemblies used for coupling an orthodontic wire to an orthodontic auxiliary. The term “orthodontic auxiliary”, as used herein, is defined as any accessory device or appliance that facilitates the application of forces in orthodontic treatment. Primary auxiliaries include bite correctors or force modules that apply therapeutic forces between two or more locations in the oral cavity. Auxiliaries used in Class II and Class III correction, for example, often employ force modules acting between appliances located on the upper and lower arches. However, auxiliaries may also exert and/or direct forces between two different portions within the same arch. As further alternative, auxiliaries may direct and/or exert forces between a wire and a fixed appliance such as a bracket, or between a bracket and a temporary anchorage device such as a mini-screw implant.

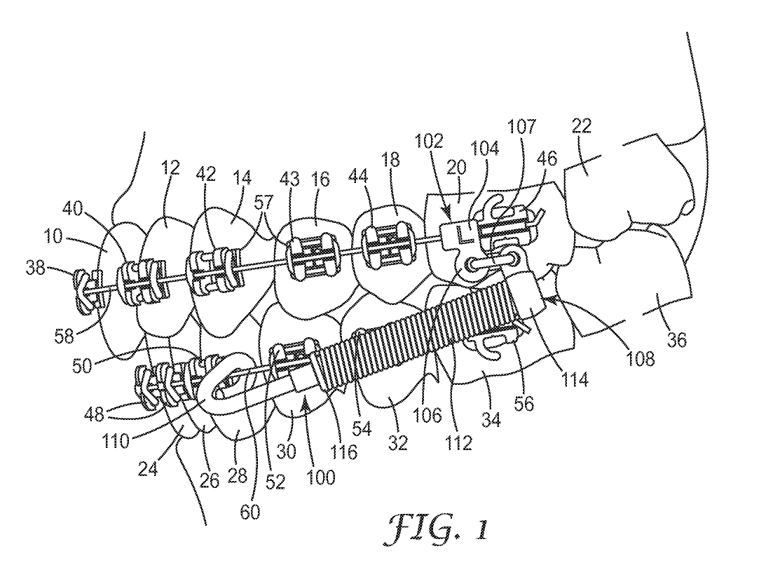

An exemplary embodiment of the present invention is shown in FIG. 1. This figure depicts an orthodontic assembly, which is designated herein by the numeral 100. The assembly 100 is installed on the left side of the upper and lower jaws of a patient, which are illustrated in profile view. As shown, the teeth of the upper jaw include an upper central 10, upper lateral 12, upper cuspid 14, upper first bicuspid 16, upper second bicuspid 18, upper first molar 20, and upper second molar 22. Similarly, the teeth of the lower jaw include a lower central 24, lower lateral 26, lower cuspid 28, lower first bicuspid 30, lower second bicuspid 32, lower first molar 34 and lower second molar 36.

Bonded orthodontic appliances are affixed to the respective teeth of both the upper and lower arches. Appliances attached to the upper arch include upper central bracket 38, upper lateral bracket 40, upper cuspid bracket 42, upper first bicuspid bracket 43, upper second bicuspid bracket 44, and upper first buccal tube 46. Appliances attached to the lower arch include lower anterior brackets 48, lower cuspid bracket 50, lower first bicuspid bracket 52, lower second bicuspid bracket 54, and lower first buccal tube 56. Each bracket and buccal tube includes a base for bonding the appliance to the facial surface of its respective tooth. As shown, each bracket further includes an archwire slot with an opening oriented towards the facial direction.

Each of the upper appliances is connected to an upper wire 58 and each of the lower appliances is connected to a lower wire 60. In this example, both upper and lower wires 58,60 have generally rectangular cross-sections in planes perpendicular to their longitudinal axes. An elastomeric O-ring ligature 57 extends around each of the bracket tiewings to retain the respective wire 58,60 in its archwire slot. Optionally, the distal ends of the wires 58,60 are bent as shown in FIG. 1 in a location adjacent the distal side of the respective buccal tube 46,56.

The assembly 100 includes a combination of elements that cooperate in applying a therapeutic force between the upper and lower dental arches. In the embodiment shown, the assembly 100 includes a connector 102 and a force module 108, which are coupled to the upper and lower wires 58,60, respectively. On one end, the connector 102 is coupled to the upper wire 58 between the upper second bicuspid bracket 44 and the upper buccal tube 46. On the opposite end, the force module 108 couples to the lower wire 60 between the lower cuspid bracket 50 and lower first bicuspid bracket 52.

In more detail, the connector 102 includes a body 104, labeled ‘L’ to convey that this device is intended for use on the left side of the dental arch. An annular attachment loop 106 extends outwardly from the occlusal side of body 104, thereby providing a means to couple the connector 102 to adjoining components. As an alternative to the attachment loop 106, a hook, crimp, latch, or any other suitable coupling may be used. Unlike brackets and buccal tubes, the connector 102 lacks a bonding base that is adapted for attaching the connector 102 to the surface of a tooth. In particular, the connector 102 lacks a concave external bonding base surface that matches a convex tooth surface, and lacks a material for enhancing the bond to a tooth surface such as grooves, particles, recesses, undercuts or a chemical bond enhancement material.

Optionally and as shown, a generally “D”-shaped linkage 107 couples the attachment loop 106 to the force module 108. The linkage 107 extends in a generally distal direction during use as shown in FIG. 1 and provides a limited degree of freedom for the force module 108 to pivot with respect to the attachment loop 106 in directions about reference axes extending in generally facial-lingual directions and about reference axes generally parallel to the longitudinal axis of the force module 108. Additional details pertaining to the linkage 107 are described in co-pending U.S. provisional patent application Ser. No. 61/168,960, filed Apr. 14, 2009. If further restriction of pivotal motion is desired, the attachment loop 106 may alternatively couple directly to the force module 108.

Preferably, the force module 108 shares aspects with the bite corrector described in U.S. Pat. No. 5,964,588 (Cleary). In brief, the force module 108 includes a first elongated tubular member, a second elongated tubular member that is received in the first member in sliding, telescoping relation, and a third member 110 that is received in the second member. A helical compression spring 112 extends around the first tubular member and has an outer end that bears against a distal end cap 114 of the force module 108 that is fixed to the first member. The opposite end of the spring 112 bears against an annular fitting 116 that is secured to an outer end section of the second member. Optionally, the outer mesial end of the third member 110 is formed into a loop-type configuration as shown in FIG. 1 that extends around a section of the lower wire 60. Additional examples of loop-type configurations are set out in U.S. Pat. No. 6,669,474 (Vogt). Other constructions for connecting a force module to an orthodontic wire are described in co-pending U.S. provisional patent application Ser. No. 61/168,946, filed Apr. 14, 2009. In some embodiments, the outer end of the third member 110 also includes a line of weakness such as a recess or other area of reduced thickness for ease of bending the outer end section around the lower wire 40. Examples of suitable commercially-available force modules 108 are included in the FORSUS brand fatigue resistant Class II correctors from 3M Unitek Corporation (Monrovia, Calif.).

When the assembly 100 is connected to the wires 58,60 in the manner described, the helical compression spring 112 urges the connector 102 and the third member 110 in directions away from each other. As a result, the connector 102 slides distally along the wire 58 until it bears against the mesial side of buccal tube 46, while the third member 110 slides mesially along wire 60 until it bears against the distal side of the bracket 50. Other aspects of operating the assembly 100 are similar to those of the appliance described in issued U.S. Pat. No. 6,558,160 (Schnaitter et al.).

The connector 102 of the assembly 100 may be used with other types of force modules as well, and its use need not be limited to telescopic force modules such as the force module 108 shown. For example, the attachment loop 106 of the connector 102 may be coupled to a flat spring made from a shape-memory alloy such as disclosed in issued U.S. Pat. No. 5,752,823 (Vogt). Likewise, the connector 102 may be coupled to any other resilient elongated body that is bendable in an arc about references axes perpendicular to its longitudinal axis.

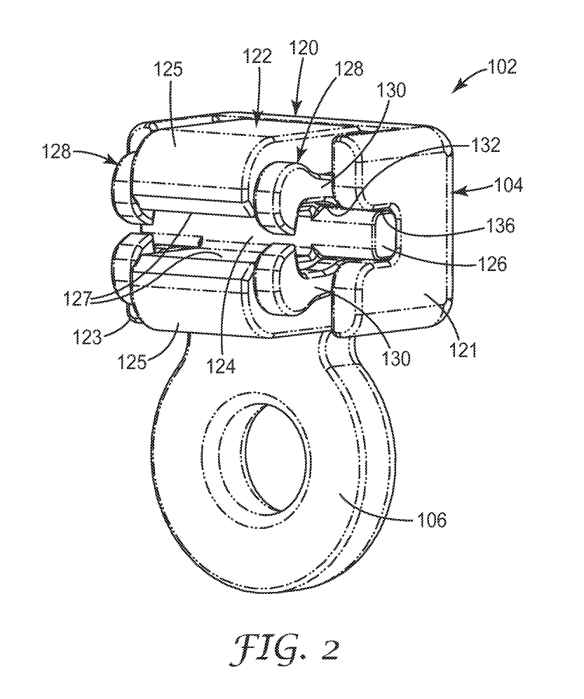

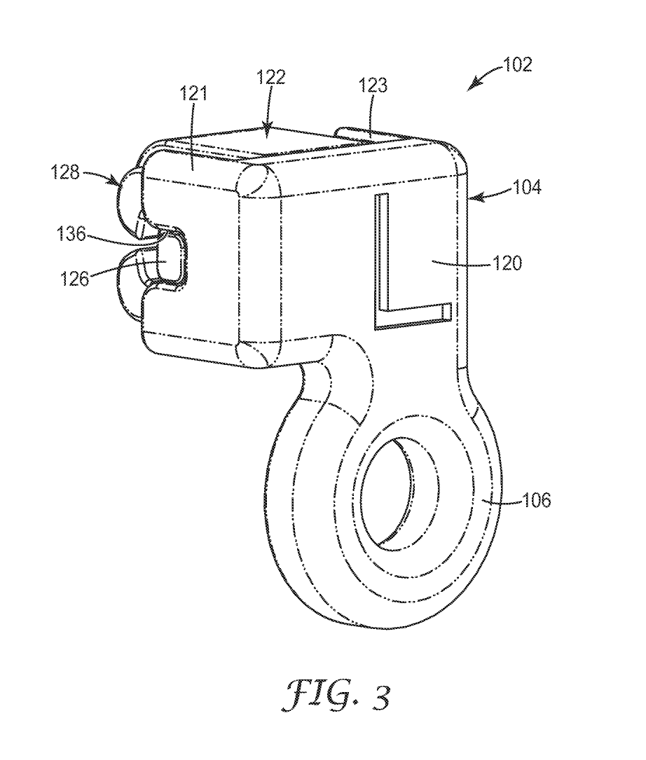

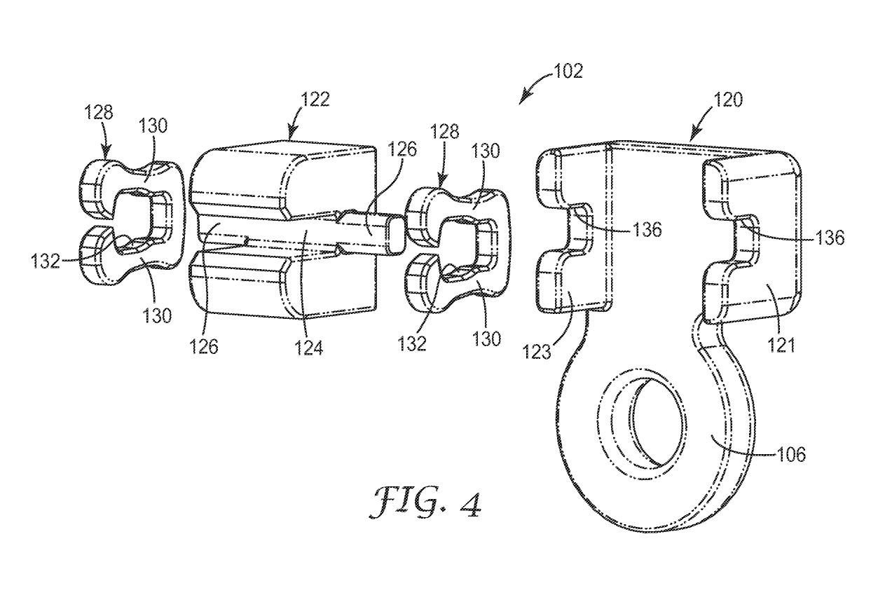

The connector 102 is displayed in greater detail in FIGS. 2 and 3, which show aspects of the connector 102 as viewed in generally lingual and facial directions, respectively. FIG. 4 additionally displays the connector 102 in an exploded configuration in order to further illuminate aspects of its constituent components.

As shown in FIG. 2, the connector 102 includes an outer section 120 and an inner section 122, joined in mating engagement. The outer section 120 extends across the entire facial side of the inner section 122, while further including mesial and distal end members 121,123 that extend in the lingual direction along the respective mesial and distal sides of the inner section 122. An elongated wire slot 124, having a generally “U”-shaped configuration in sections transverse to its longitudinal axis, extends across the lingual side of the inner section 122. The inner section 122 further includes a pair of protrusions 126 extending outwardly in the mesial and distal directions from the section 122 along an axis parallel to the longitudinal axis of the slot 124. As shown, the lingual sides of the protrusions 126 are co-planar with the bottom of the slot 124. The lingual edges of the end members 121,123 include notches 136, which are complemental to the protrusions 126. The notches 136 receive the outer ends of the protrusions 126 of the inner section 122, thereby providing mating surfaces by which the sections 120,122 precisely register with each other.

The inner section 120 further includes a pair of generally rectangular posts 125 that protrude in the lingual direction from the connector body 104 thereby providing the wire slot 124 with rigid and opposing walls 127 (as shown in FIG. 2). The rigid and opposing walls 127 of slot 124 advantageously restrict relative rotation of the connector body 104 about the longitudinal axis of the rectangular wire 58 (such as shown in FIG. 1) while the wire is retained in the slot 124. By restricting the rotational freedom of the connector body 104, this configuration presents a substantial improvement over previous approaches. Rotational restriction allows the intra-oral position of the force module 108 to be precisely controlled, including during mastication and other kinds of jaw movement. This in turn allows the connector 102 to be optimally oriented relative to the force module 108 for enhanced patient comfort while preventing the force module 108 from rotating into the occlusion.

Preferably the distance between the walls 127 is sufficiently large to allow the slot 124 to easily accommodate a full-sized rectangular wire, while sufficiently narrow to prevent significant rotation of the connector 102 about the longitudinal axis of the wire after installation. In most cases, this distance between walls 127 is approximately equivalent to the slot dimensions of the fixed appliances being used in treatment. For example, orthodontic brackets with a “022 slot” may be used with a connector 102 with a slot 124 having a 0.022 in. height in an occlusal-gingival direction, and brackets with a “018 slot” may be used with a connector 102 with a slot 124 having a 0.018 in. height in an occlusal-gingival direction. However, the occlusal-gingival height of the slot 124 may be intentionally enlarged by one or two hundredths of a millimeter to allow for some degree of rotation of the connector 102 about the longitudinal axis of the wire 58. If desired, the entrance to the slot 124 may additionally include chamfered wall sections, thereby presenting a tapered (or funneled) lead-in to facilitate receiving the wire 58 in the slot 124.

Sections 120,122 are preferably made from a stainless steel alloy and formed using a MIM (metal injection molding) process. However, other manufacturing methods such as milling, conventional molding, or investment casting may also be used. If desired, one or more of these parts can also be manufactured from other classes of materials, such as ceramics or polymeric composites.

The connector 102 further includes a pair of clips 128, which have a generally “C”-shaped configuration and are located in the recesses formed between the inner and outer sections 122,120. Each clip 128 includes a pair of arm portions 130 that extend in the lingual directions and then bend inwardly toward each other. Within each clip 128 is a wire-receiving region 132 that is aligned with the slot 124. The protrusions 126 of the inner section 122 extend through the clips 128 in locations facial to the wire-receiving regions 132, thereby retaining the clips 128 in the body 104.

The pair of clips 128 are disposed adjacent to the respective mesial and distal sides of the connector 102 and releasably retain the wire 58 (not shown in FIGS. 2-4) in the slot 124 when the assembly 100 is in operation as shown in FIG. 1. Using a dual clip configuration provides improved stability over using a single clip by leveraging two engagement points along the wire 58. Having two engagement points helps prevent the connector 102 from rotating about its occlusal-gingival axis, thereby resulting in a more secure coupling.

The clips 128 are shown in their normal, relaxed orientations in FIGS. 2, 3, and 4. However, the arm portions 130 of each clip 128 are movable away from each other in order to admit the wire 58 into a wire-receiving region 132 when so desired. The smooth, outer edge of the arm portions 130 enables each clip 128 to receive a wire by pressing the wire 58 against the outer curved edges of the arm portions 130. As pressure is exerted by the wire 58 on the curved edges, the arm portions 130 deflect away from each other in order to admit the wire 58 into the wire-receiving region 132.

Once the wire 58 is received in the wire-receiving region 132, the inherent resiliency of each clip 128 enables arm portions 130 to spring back toward each other and toward their normal, relaxed configuration as shown in FIGS. 2, 3, and 4 to retain the wire 58 in the wire slot 124. In some embodiments, the wire-receiving region 132 is somewhat larger than the cross-section of the wire in directions along both an occlusal-gingival reference axis as well as along a facial-lingual reference axis, thereby avoiding firm contact between each clip 128 and the wire 58.

The spaces between each clip 128 and the wire 58 provide what is referred to as a “passive” clip. When the wire 58 is retained in the slot 124, a passive clip allows the connector 102 to slide freely along the wire 58. If desired, the dimensions of the clips 128 may be modified to eliminate the spaces between each clip 128 and the wire 58, resulting in an “active” clip. If one or more “active” clips are used, the clip may apply sufficient compressive force to the wire 58 to prevent movement of the connector 102 in directions along the longitudinal axis of the wire. Optionally, inner surfaces of the clips 128 may be roughened or knurled or provided with serrations, grooves or other structure to facilitate a secure, non-sliding connection between the clips 128 and the wire.

Using an active clip can be advantageous for several reasons. When sliding movement between the connector 102 and the wire 58 is prevented, the force module bears on the wire 58 rather than the buccal tube 46. While it depends on the treatment plan contemplated by the orthodontist, such a re-direction of force may be used for clinical advantage—for example, to move all of the upper teeth en masse relative to the lower arch. As another potential benefit, the lack of sliding provides a more predictable force vector between the upper and lower arches. Finally, fixing the connector 102 to the wire 58 effectively eliminates the possibility of collision between the connector 102 and the bracket 44 or buccal tube 46 during treatment. Appliance bond failures attributable to these collisions would therefore be eliminated.

Each clip 128 (including the arm portions 130) is sufficiently stiff to retain the wire in the wire slot 124 during the course of treatment so long as the forces exerted by the wire on the connector 102 remain below a certain minimum value in a generally facial direction (or in a direction opposite to the direction of insertion of the wire into the wire slot 124). However, whenever the forces exerted by the wire on the connector 102 in the same direction are greater than the minimum value, the arm portions 130 can move apart from each other to open the clip 128 and release the wire from the wire slot 124. Further details regarding clip forces are described in the aforementioned U.S. Pat. Nos. 6,302,688 (Jordan et al.) and 6,582,226 (Jordan et al.).

Each clip 128 preferably releases the wire from the wire slot 124 in a generally facial direction whenever the wire exerts a force in the same direction on the connector 102 that is in the range of about 0.2 lb (0.1 kg) to about 11 lb (5 kg), more preferably in the range of about 0.4 lb (0.2 kg) to about 5.5 lb (2.5 kg), and most preferably in the range of about 0.75 lb (0.34 kg) to about 3.0 lb (1.4 kg). Preferably, the minimum value is sufficiently high to prevent the wire from unintentionally releasing from the wire slot 124 during the normal course of orthodontic treatment. As such, the force module 108 can exert expansive forces on the connector 102 and the third member 110 sufficient to carry out the treatment program and move the associated teeth as desired.

To determine the force to release each clip 128, a section of wire is selected having an area in longitudinally transverse sections that is complemental to (i.e., substantially fills) the cross-sectional area of the wire slot 124. Next, a sling is constructed and is connected to the wire section at locations closely adjacent to, but not in contact with, the end members 121,123. Optionally, the sling is welded or brazed to the wire section. Next, the sling is pulled away from the connector 102 while the connector 102 is held in a stationary position, taking care to ensure that the longitudinal axis of the wire section does not tip relative to the longitudinal axis of the wire slot 124. The force to release each clip 128 may be determined by the use of an Instron testing apparatus connected to the sling, using a crosshead speed of 0.5 in/min (1.3 cm/min). Alternatively, a cyclic tester (such as Model 300 from APC Dynamics of Carlsbad, Calif.) may be used along with a force transducer (such as Model 208C01 from PCB of Buffalo, N.Y.) to measure the force.

Optionally, each of the clips 128 is cut from a flat section of metallic stock material. Suitable metallic materials include shape memory alloys such as alloys of nitinol and beta-titanium. The clips 128 may be cut from the stock material using a stamping, die cutting, chemical etching, EDM (electrical discharge machining), laser cutting or water jet cutting process. As another option, the clips 128 could be formed and then heat-treated to set its shape. The clips 128 may also be made from a suitable plastic such as described in issued U.S. Pat. No. 7,070,410 (Cacchiotti et al.). Other suitable clips and possible optional features are given in issued U.S. Pat. Nos. 7,252,505 (Lai) and 7,367,800 (Lai et al.).

The manner of assembly of the outer section 120, inner section 122, and clips 128 to form the connector 102 is shown by the spatial arrangement of these components in FIG. 4. In one exemplary method, assembly takes place in two steps. First, the clips 128 are aligned around the respective mesial and distal protrusions 126 of inner section 122. Second, the inner section 122 and clips 128 are joined with the outer section 120 such that the protrusions 126 are received in the notches 136 and the clips 128 are captured between inner section 122 and the end members 121,123 of the outer section 120. Preferably, there is a sufficient space between the facial surfaces of the clips 128 and the adjacent lingual surface of the outer section 120 for the clips 128 to flex open and closed without interference.

In some embodiments, the inner and outer sections 120,122 are subsequently welded to each other using a resistance or laser welding process. Alternatively, the sections 120,122 may be adhesively or chemically bonded to each other using, for example, a chemically-cured polymerizable epoxy or acrylic resin. As a further alternative, the sections 120,122 may be joined in press-fit, snap-fit or interference-fit relation such that subsequent separation does not occur. If an interference fit is desired, one or both sections 120,122 may have mating, interlocking structures that snap together when the sections 120,122 are fully engaged with each other.

As described above, the orthodontic assembly 100 applies corrective forces on the left side of the dental arch. It is understood, however, that mirror images of the configurations shown in FIGS. 1-4 are likewise contemplated for treating the right side of the dental arch. Generally when treating Class II malocclusions, a pair of orthodontic assemblies 100 are symmetrically disposed on the left and right sides of the patient's arch. Depending on the patient's particular treatment plan, however, the orthodontist may choose to use the assembly 100 on only one side of the arch. As another option, the orthodontist may prescribe using a pair of assemblies 100 as described above but with an asymmetric activation of the force modules 108 on the left and right sides of the arch.

The configuration of connector 102 confers several advantages to the orthodontist. First, it provides a simple and convenient “snap-in” mechanism that releasably couples the distal end of the assembly 100 to the wire 58 without need for loose auxiliary pieces such as screws, ligature wire, or wrenches. The connector 102 can be readily engaged or disengaged from the wire 58 using a pair of standard orthodontic utility pliers such as Weingart or How pliers. This mode of installation is convenient and saves time for the orthodontist when compared with the installation procedures for other Class II correctors on the market.

As a second advantage, this engagement mechanism provides a high degree of control and predictability by constraining the position of the installed connector 102 relative to the wire 58. Provided that the wire size is known, the allowable facial rotation of the force module and range of pivoting can be precisely controlled based on the dimensions of the space between the rigid and opposing walls 127. Third, the clips 128 are not only oriented towards the lingual direction away from the patient's cheeks but also protected in the confines between the inner and outer sections 120,122, thereby minimizing the risk of tissue irritation from the edges of the clips during treatment.

As a third advantage, the direction from which the connector 102 engages the wire 58 leads to enhanced rotational control. Since the opening of the slot 124 faces the lingual direction, or towards the short occlusal-gingival dimension of the wire 58, the rigid and opposing walls 127 can flatly engage the wire 58 along the entire length of the long facial-lingual dimension. By engaging along the long dimension, rather than the short dimension, of the wire 58, the connector 102 benefits from a high degree of rotational control about the longitudinal axis of the wire 58. Engaging the wire 58 from the lingual direction also provides a convenient angle of approach for the installing orthodontist.

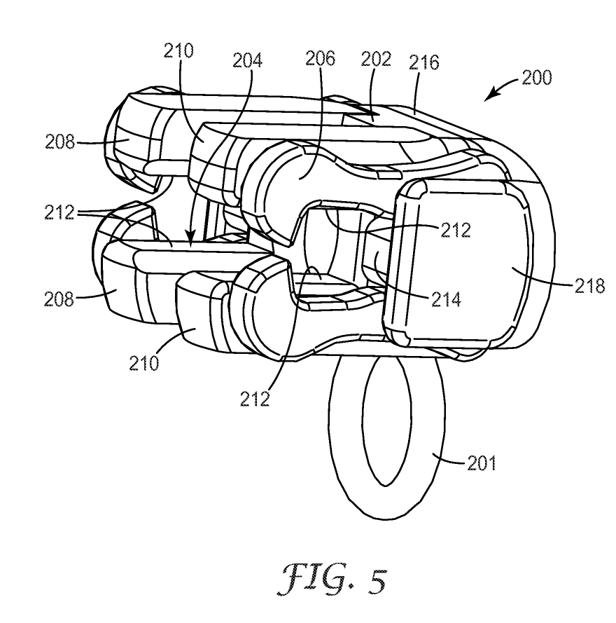

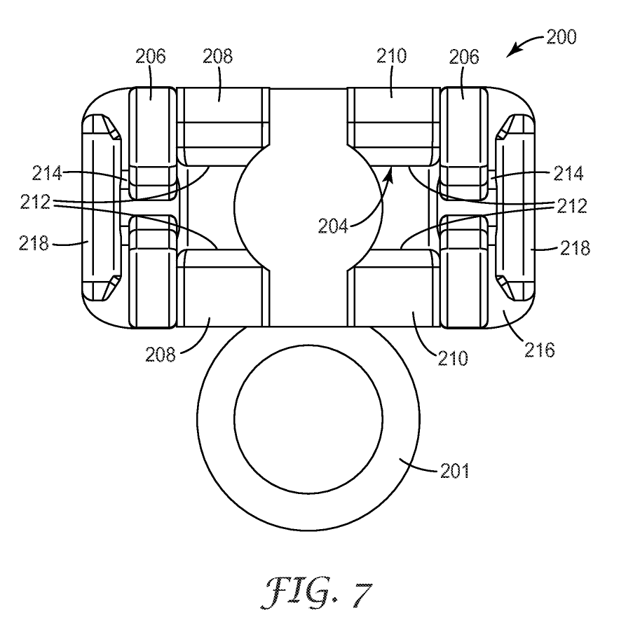

An alternative embodiment of the present invention is illustrated in FIGS. 5, 6, and 7. These figures show a connector 200 in perspective view, occlusal view, and facial view, respectively. The connector 200 is similar in some respects to the connector 102 in FIGS. 1-4. For example, the connector 200 has a connector body 202, an attachment loop 201 protruding in the occlusal direction from the body 202, a wire slot 204 extending in the mesial-distal direction across the connector body 202, and a pair of “C”-shaped clips 206 for releasably retaining a wire in the slot 204.

Particular to this embodiment, a pair of mesial posts 208 and a pair of distal posts 210 extend outwardly from the lingual side of the body 202 such that the slot 204 extends between each of the pairs of posts 208,210. The sides of the posts 208,210 adjacent to the slot 204 present opposing walls 212. Together, the lingual side of 202 and walls 212 define three sides of the slot 204 that are rigid and restrict rotation of the body 202 relative to the longitudinal axis of a rectangular wire while the wire is retained in the slot 204.

The clips 206 are retained against the body 202 by protrusions 214 which project from the body 202 and extend through each respective clip 206. Each protrusion 214 terminates with an oversized end cap 218. End caps 218 retain the clips 206 along the mesial and distal sides of the body 202 and prevent undesirable sliding movement of the clips 206 along the longitudinal axes of the protrusions 214.

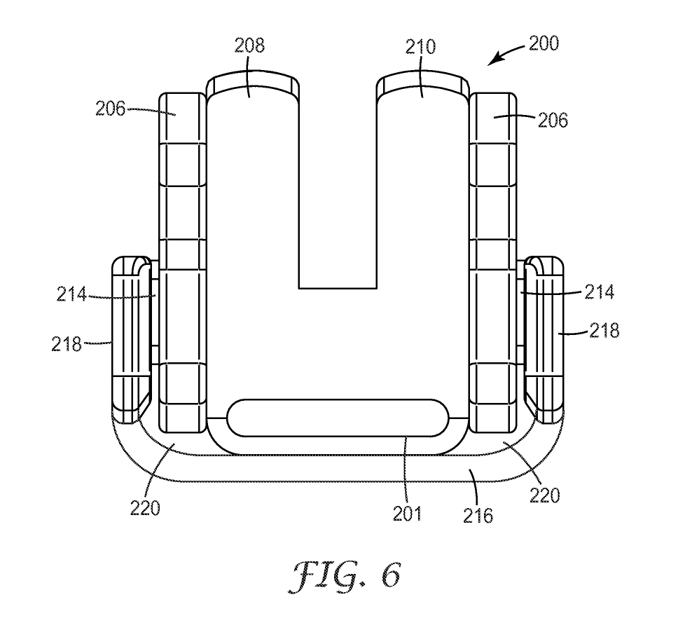

A cover plate 216 extends across the facial side of body 202. Optionally and as shown in FIG. 6, the cover plate 216 extends across the entire mesial-distal width of connector 200. For a secure attachment, it is preferable that the cover plate is welded or adhesively bonded to the facial side of each end cap 218 along with the facial side of body 202. Also preferably, the facial side of the cover plate 216 has smooth, rounded contours for patient comfort. As shown in FIGS. 5-7, the cover plate 216 overlaps the facial sides of the clips 206, thereby preventing the clips 206 from sliding off the protrusions 214 in the facial direction. Preferably and as shown, there are gaps 220 between the facial side of each clip 206 and the cover plate 216 to allow room for the clip 206 to freely flex between open and closed positions.

Other variations are possible. For example, the cover plate 216 may be omitted altogether and clip 206 replaced with a self-retaining clip, such as described in issued U.S. Pat. Nos. 7,252,505 (Lai), 7,217,125 (Lai et al.), and 7,377,777 (Lai et al.). Such clips can be mechanically retained on the protrusions 214 of the connector body 202 without need for additional structure on the facial side of the clip. Other aspects of connector 200 are similar to those of the connector 102 and will not be repeated here.

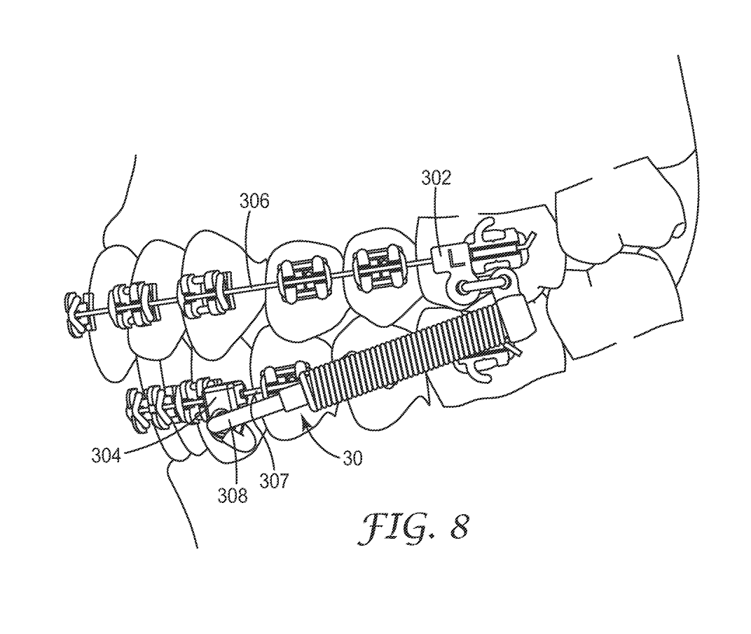

FIG. 8 shows an orthodontic assembly 300 according to another embodiment of the invention. Assembly 300 is shown coupled to upper and lower wires 306,307, and differs from assembly 100 in that it includes a mesial connector 304 releasably coupled to the lower wire 307 using resilient clips. The mesial loop at the end of the third section 308 is oriented slightly differently to engage with the mesial connector 304. Advantageously, both distal connector 302 and the mesial connector 304 resiliently “snap-on” to respective upper and lower wires 306,307, providing even further enhanced ease-of-use. Other aspects of assembly 300 are similar to those previously discussed.

In alternative embodiments, one or more of the orthodontic assemblies above are adapted to correct a Class III malocclusion. Such correction may be achieved, for example, by connecting the one end of the assembly to the wire 58 between the upper cuspid 42 and upper first bicuspid 43 and the other end of the assembly to the wire 60 distal to the lower first buccal tube 56. Similar configurations to treat Class III malocclusions are described in issued U.S. Pat. No. 6,558,160 (Schnaitter et al.).

In further alternative embodiments, the connector 102,202 is coupled to a segment of orthodontic wire extending along only a portion of the upper or lower dental arch.

Orthodontic brackets need not be present in these configurations. For example, the connector may be coupled to a short segment of rectangular wire whose ends are adhesively bonded to the facial surfaces of two adjacent teeth. As another example, the connector may be coupled to a segment of wire with a rectangular cross-section protruding from a fixed appliance bonded to the surface of a tooth.

In still further alternative embodiments, one or more of the assemblies above are adapted for connection to two different locations within the same arch.

Further variants of the devices and assemblies above are contemplated in which the connector engages the wire from other directions besides the facial direction. These devices and assemblies could, for example, be implemented with one or more clips that are coupled to the connector and engage the wire from either the occlusal or gingival directions. If this were desired, the clip dimensions should be properly modified to accommodate the long dimension (facial-lingual dimension) of the wire. Such a connector configuration may be advantageously used on either the mesial or distal end of the force module to provide an overall lower profile appliance.

All of the patents and patent applications mentioned above are hereby expressly incorporated by reference. The embodiments described above are illustrative of the present invention and other constructions are also possible. Accordingly, the present invention should not be deemed limited to the embodiments described in detail above and shown in the accompanying drawings, but instead only by a fair scope of the claims that follow along with their equivalents.

1. An orthodontic assembly comprising:
a set of brackets;
a wire connected to the brackets; and
a connector for coupling an orthodontic auxiliary to the wire, the connector comprising:
a body;
a slot extending across the body; and
a clip coupled to the body, wherein the clip releasably retains the wire in the slot and wherein the slot includes a pair of rigid and opposing walls that restrict rotation of the connector body about the longitudinal axis of the wire.

2. The assembly of claim 1, wherein the clip engages the wire at a position between two adjacent brackets.

3. The assembly of claim 1, wherein the slot extends across the lingual side of the body.

4. The assembly of claim 1, further comprising the orthodontic auxiliary, wherein the auxiliary is a force module and the force module is coupled to the body.

5. The assembly of claim 4, wherein the connector is a distal connector and further comprising a mesial connector having a configuration similar to the configuration of the distal connector and coupled to the mesial end of the force module.

6. The assembly of claim 1, wherein the connector lacks a bonding base that is adapted for attaching the connector to the surface of a tooth.

7. An orthodontic assembly comprising:
a connector for coupling a wire to an orthodontic auxiliary, the connector comprising:
a body having a lingual side;
a slot extending across the lingual side of the body; and
a clip coupled to the body for releasably retaining a wire in the slot, wherein the slot includes a pair of rigid and opposing walls that restrict rotation of the connector body about the longitudinal axis of a wire relative to the body while the wire is retained in the slot.

8. The assembly of claim 7, further comprising the orthodontic auxiliary, wherein the auxiliary is a force module and the force module is coupled to the body.

9. The assembly of claim 7, wherein the clip is generally “C”-shaped and has an opening that faces a certain direction and further wherein the clip disengages from the wire whenever the clip exerts a force greater than about 2.3 kg against the wire in a direction opposite to the certain direction.

10. The assembly of claim 7, wherein the clip is made from a shape memory alloy.

11. The assembly of claim 7, further comprising an attachment loop extending from the body and wherein the auxiliary is coupled to the attachment loop.

12. The assembly of claim 11, further comprising a linkage wherein the linkage couples the auxiliary and attachment loop to each other.

13. The assembly of claim 8, wherein the force module is a telescopic spring module.

14. The assembly of claim 8, wherein the force module comprises a resilient elongated body that is bendable in an arc about references axes perpendicular to its longitudinal axis.

15. The assembly of claim 7, wherein the clip is active when a wire is retained in the slot.

16. The assembly of claim 15, wherein the active clip prevents movement of the body along the wire in directions along the longitudinal axis of the wire.

17. The assembly of claim 7, further comprising a pair of posts extending outwardly from the lingual side of the connector body, wherein the slot extends between the posts and the rigid and opposing walls are defined by the posts.

18. The assembly of claim 7, wherein the connector body includes mesial and distal sides and further comprising a second clip wherein the two clips are disposed adjacent to the mesial and distal sides of the connector body.

19. An orthodontic connector comprising:
a body;
a slot extending across the body; and
a clip coupled to the body for releasably retaining a wire in the slot, wherein the slot includes a pair of rigid and opposing walls that restrict rotation of the connector body about the longitudinal axis of a wire relative to the body while the wire is retained in the slot, and further wherein the connector lacks a bonding base that is adapted for attaching the connector to the surface of a tooth.

20. The connector of claim 19, further comprising an attachment loop extending from the body for coupling to an orthodontic auxiliary.

21. A method of coupling a force module to a wire comprising:
providing a force module coupled to a connector;
moving the connector in a direction toward a wire;
sliding a pair of rigid and opposing walls of the connector along opposite sides of the wire; and
coupling the connector to the wire by engaging the wire with at least one resilient clip of the connector such that the sides of the wire are adjacent the rigid walls.

22. The method of claim 21, wherein the force module includes two ends, one of which is coupled to the connector, and further comprising coupling the opposite end of the force module to an anterior section of the same wire or a different wire.
